(19) United States
(12) Patent Application Publication
(10) Pub. No.: US 2015/0291733 A1
(43) Pub. Date: Oct. 15, 2015

(54) METHOD FOR THE PRODUCTION OF A HIGH-MOLECULAR POLYESTER OR COPOLYESTER AND ALSO OF A POLYMER BLEND COMPRISING THESE

(71) Applicant: UHDE INVENTA-FISCHER GMBH, Berlin (DE)

(72) Inventors: Christopher Hess, Schönfließ (DE); Rainer Hagen, Berlin (DE)

(73) Assignee: UHDE INVENTA-FISCHER GMBH, Berlin (DE)

(21) Appl. No.: 14/438,024

(22) PCT Filed: Oct. 29, 2013
(86) PCT No.: PCT/EP2013/072625

§ 371 Date: Apr. 23, 2015

(30) Foreign Application Priority Data
Oct. 29, 2012 (EP) 12190403.1

(51) Int. Cl. C08G 63/85

(52) U.S. Cl. CPC C08G 63/85

(57) ABSTRACT

The invention relates to a method for the production of a high-molecular polyester or copolyester which comprises at least three method steps. In a first method step, a paste is produced from at least one aromatic dicarboxylic acid or the diester thereof or the acid anhydride thereof and also from at least one aliphatic dicarboxylic acid or the diester thereof or acid anhydride thereof and also from at least one dialcohol and also the required quantity of transesterification- or polycondensation catalyst. This paste is converted into a prepolymer in a second step at increased temperature and, in the third method step, this obtained prepolymer is polycondensed or copolycondensed at reduced pressure relative to normal conditions. The implementation of the method can be effected continuously and also discontinuously. Furthermore, the invention relates to polyesters and copolyesters produced in this way and also to biodegradable polymer blends comprising these. The polyesters and copolyesters according to the invention are used for the production of compostible moulded articles, biodegradable foams and paper-coating means.

The invention relates to a method for the production of a high-molecular polyester or copolyester which comprises at least three method steps. In a first method step, a paste is produced from at least one aromatic dicarboxylic acid or the diester thereof or the acid anhydride thereof and also from at least one aliphatic dicarboxylic acid or the diester thereof or acid anhydride thereof and also from at least one dialcohol and also the required quantity of transesterification- or polycondensation catalyst. This paste is converted into a prepolymer in a second step at increased temperature and, in the third method step, this obtained prepolymer is polycondensed or copolycondensed at reduced pressure relative to normal conditions. The implementation of the method can be effected continuously and also discontinuously. Furthermore, the invention relates to polyesters and copolyesters produced in this way and also to biodegradable polymer blends comprising these. The polyesters and copolyesters according to the invention are used for the production of compostible moulded articles, biodegradable foams and paper-coating means.

In the state of the art, different polymers have been known for many decades for various applications. By way of example, polyolefins, polyesters, polyamides, polyacrylates or also polycarbonates should be mentioned here. The selection of these different polymer materials is based in general upon the purpose of use and the sought mechanical properties, such as e.g. strength, impact strength, chemical or temperature resistance. Aromatic polyesters which are obtained by esterification and polycondensation of terephthalic acid with ethylene glycol or butylene glycol are frequently used. Although the polymers obtained therefrom, polyethylene terephthalate (PET) or polybutylene terephthalate (PBT), have excellent properties, they are however not biodegradable. This is disadvantageous for many applications, in particular wherever articles produced from these polymers are not recirculated for recycling or specialist disposal and then lead to environmental pollution. In addition, biodegradability of polymers is of great advantage in particular when the polymers, e.g. in the form of films, fibres, nonwovens, foams or moulded articles in agriculture, compost preparation or in maritime applications, do not require to be separated and/or collected after use in a complex manner but can remain in the environment and be degraded there.

Biodegradable polymers used for these purposes are frequently exclusively polyesters constructed from aliphatic components, such as e.g. polycaprolacton or polybutylene adipate. Because of their frequently inadequate mechanical properties and also in particular their low temperature resistance, they can however be used only in very few applications, such as e.g. as films in agriculture or for medical purposes.

In order to improve the mechanical properties of the biodegradable polyesters, a part of the aliphatic components was replaced by aromatic compounds, such as in particular terephthalic acid. However, this is only possible within certain limits since the biodegradability is reduced with an increasing proportion of the aromatic component. Such biopolymers based on copolyesters of aromatic and aliphatic dicarboxylic acids have been developed since the 1990s, such as e.g. polytetramethylene adipate terephthalate (PBAT or alternatively also designated PTMAT) or polytetramethylene succinate terephthalate (PBST).

In the case of polymer materials which have been known for many decades, it is however problematic that the educts for the production of such polymers, such as e.g. the aromatic structural elements terephthalic acid or isophthalic acid or the aliphatic dicarboxylic acids, adipic acid or succinic acid and also the aliphatic alcohols butanediol or ethylene glycol, originate from fossil sources. There is therefore a high market demand for polymer materials, in particular also for biodegradable polyesters, in which educts which are obtained essentially from renewable raw materials are used for the production of the polyesters. Therefore, there has been no lack of attempts in the past to produce such polymers and in particular polyesters which have biodegradability and consist ideally of renewable raw materials. There should be mentioned hereby as examples, polylactide (PLA) and also polybutylene succinate (PBS) since commercial possibilities have been found for the monomer structural elements required herefor, lactic acid, succinic acid or butanediol, of obtaining these from renewable raw materials. Also technological possibilities are emerging of making terephthalic acid available from renewable raw materials, or of replacing aromatic dicarboxylic acid which has been used to date by heteroaromatic dicarboxylic acids. Such heteroaromatic dicarboxylic acids, such as e.g. 2,5-furandicarboxylic acid, are readily available from renewable raw materials and, in the case of substitution of the previously used aromatic component, terephthalic acid, produce polymers with a property level which is very similar hereto.

For the commercial production of conventional polyesters and also biodegradable polyesters, catalysts or combinations of catalysts with stabilisers and deactivators are required. Various metal-containing catalysts are used, according to the state of the art, for the production of terephthalic acid-containing polyesters, such as PET or PBT or aliphatic polyesters, such as e.g. compounds of antimony, tin or titanium. MacDonald (Polym. Int. 51:923-930 (2002)) describes, in his publication, the use of titanium-based catalysts for the production of the polyester, based purely on terephthalic acid, polyethylene terephthalate. In particular, the titanium-based catalysts are distinguished by having an increased activity relative to the antimony catalysts preferred by industry. However, the titanium catalysts of the first generation, such as in particular titanium alkoxides, such as tetra-n-butylorthotitanate or simply constructed chelate complexes, display in fact the desired increased reaction rates but they are susceptible to hydrolysis reactions in which oxoalkoxides are formed, which then have however only a low catalytic activity.

For the production of aliphatic polyesters, such as e.g. PBS, in particular titanium alkoxides are used, which however frequently lead to low molar masses of the polymers which are not adequate for commercial applications. The molar masses required for this purpose are achieved only by a chain-lengthening step, e.g. by using reactive and toxic hexamethylene diisocyanate.

WO 96/015173 describes biodegradable polyesters based on aliphatic and aromatic dicarboxylic acids and also aliphatic dihydroxy compounds. The production of these polyesters is indicated basically as known, transesterification-, esterification- and polycondensation reactions according to the state of the art being able to be used. In the course of production, further comonomers and also chain branching agents and/or chain lengtheners based on diisocyanates can be added. The production is effected with the addition of catalysts, such as the metalorganic metal compounds of Ti, Ge, Zn, Fe, Mn, Co, Zr, V, Ir, La, Ce, Li and Ca. No preferred addition locations or required quantities of the catalysts are listed.

A method for the production of a partially aromatic copolyester is known from U.S. Pat. No. 6,399,716 B2, in which an aliphatic prepolymer is produced in a first step and, in a second step, is converted with an aromatic dicarboxylic acid and an aliphatic glycol. In a third step, a quantity of aliphatic dicarboxylic acid is once again added and converted with the reaction mass. In conclusion, a two-step polycondensation of the reaction product produced in the preceding steps is effected as fourth step. The addition of the catalysts can thereby be effected at the beginning or at the end of the first, second or third and also at the beginning of the fourth reaction step. The quantity of catalyst used can be between 0.02 to 2.0% by weight. The catalysts are chosen from the group of compounds of Ti, Ge, Zn, Fe, Mn, Co and Zr, preferably metalorganic compounds of the titanates, antimonates or tin oxides. Particularly preferred titanium compounds are tetrabutyltitanate and also tetrapropyltitanate. The described embodiments always require a separate addition and conversion of the monomer units which construct the molecular chains—only in this way can a sufficiently high molecular weight be achieved. Common introduction of all the monomer units is therefore avoided. In the case of the titanium-containing catalysts which are used, alkoxides are preferred, no special hydrolysis-stable Ti compounds are used as catalysts.

In US 2006/0155099 A1, a method for the production of a biodegradable copolyester is disclosed, in the case of which firstly an aromatic dicarboxylic compound is made to react (a) with a first aliphatic glycol, the aromatic prepolymer hereby produced is converted (b) with a second aromatic dicarboxylic compound and a second aliphatic glycol in order to obtain a first reaction product; subsequently, this first reaction product is converted (c), in a further step, with an aliphatic dicarboxylic component in order to obtain a second reaction product. Finally, a polycondensation of this second reaction product is effected (d). It is described that the addition of catalysts can be conducive to the acceleration of the reaction. The addition of the catalysts is thereby effected in steps (b) and/or (d). The catalysts used concern metal-containing compounds from the group of Ti, Sb, Mn, Al, Zn, preferably Ti-containing compounds, and in particular tetrabutlyorthotitanate in a quantity of 1,500 to 3,000 ppm. The described embodiments always require a separate addition and conversion of the monomer units which construct the molecular chains. In the case of the titanium-containing catalysts which are used, alkoxides are preferred, no special hydrolysis-stable Ti compounds are used as catalysts.

In US 2011/0039999 and 2011/0034662, a continuous method for the production of biodegradable polyesters based on aliphatic and aromatic dicarboxylic acids and also aliphatic dihydroxy compounds is described. It is stated in particular that the raw materials are prepared to form a paste, however without the addition of a catalyst, i.e. the particular procedure resides in deliberate avoidance of the addition of the catalyst already at this early point in time in the method. Preferably, the main quantity of catalyst is instead added during the esterification whilst a residual partial quantity is only added at a later point in time. There are listed as catalysts, in general metal compounds of the elements Ti, Ge, Zn, Fe, Mn, Co, Zr, V, Ir, La, Ce, Li and Ca, in particular metalorganic compounds and also for particular preference alkoxides of zinc, tin and titanium, without listing the specific properties of the catalysts or the advantageous nature in the use thereof. The weight ratio of catalyst to the quantity of produced biodegradable polyester is thereby between 0.01:100 and 3:100, also smaller ratios being possible for the reactive titanium compounds. The addition of the catalyst is effected as a total quantity or divided into partial quantities from the point in time at the beginning of the reaction, i.e. at the earliest with the beginning of the transesterification- or esterification reaction, and also during the entire phase of polycondensation. However, the addition of the catalyst must in no way be effected already during the production of the paste from the educts. It can be assumed that this takes place for reasons of avoiding hydrolysis of the particularly preferred alkoxides and hence reduction in their reactivity. The addition at later points in time—in particular in parts of the plant which are operated at increased temperature and/or conditions deviating from atmospheric pressure, is frequently critical since specially suited, additional metering devices, such as e.g. piston- or gear pump metering systems, are required for this purpose, which however require a high degree of monitoring and in addition are susceptible to wear and tear. The ends of the catalyst metering lines, which are connected directly to polymer- or vapour-conducting apparatus parts, are also inclined to become blocked by polymer- or oligomer deposits so that the catalyst metering takes place still only in a reduced way or comes to a complete halt, which leads respectively to process disruptions.

It is therefore the object of the present invention to propose an improved method for the production of high-molecular copolyesters, in particular polyesters based on aromatic dicarboxylic acid, aliphatic dicarboxylic acids and aliphatic dialcohols, the production of which takes place in a simplified manner relative to the state of the art and the mechanical and physical properties of which are improved relative to the state of the art.

This object is achieved according to the invention by the method having the features of claim 1, the polyesters or copolyesters having the features of claim 13, the biodegradable polymer blend having the features of claim 16. The further dependent claims reveal advantageous developments. Uses according to the invention are indicated in claim 17.

According to the invention, a method for the production of high-molecular polyester or copolyester is provided, in which
a) in a first step, the total quantity of the monomers or oligomers which are capable of condensation reactions, comprising at least one aromatic or heteroaromatic C₄-C₁₂ dicarboxylic acid or the diesters thereof, at least one aliphatic C₂-C₁₂ dicarboxylic acid or the diesters thereof, at least one C₂-C₁₂ alkanol with at least two hydroxyl groups are processed by mixing to form a paste, at least one hydrolysis-stable catalyst being added during the production of the paste or into the already produced paste, the total quantity or a main quantity of at least 50% by weight, relative to the total quantity of the catalyst, being added,
b) in a second step, the paste is converted by increasing the temperature and with distilling-off of condensation products or transesterification products to form an esterification- or transesterification product and
c) the esterification- or transesterification product obtained from step b) is polycondensed or copolycondensed at reduced pressure relative to normal conditions up to a molecular weight Mₙ of 100,000 to 150,000 g/mol and to a relative viscosity of 1.5 to 2.0.

This is achieved by the production of a paste which already comprises all the monomer units which contribute to the chain structure by condensation reactions and also the total quantity or main quantity (i.e. at least 50% by weight) of catalyst.

Hence, the special method implementation with respect to the production of the paste and the use of particularly suitable hydrolysis-stable catalysts are an essential element of the present invention.

The person skilled in the art has to date avoided adding the catalyst directly to the paste. One reason for this is that, with the normal Ti- or Zr alkoxides, the formation of by-products from the diol components begins even at low temperatures of the paste production, such as tetrahydrofuran from butanediol or acetaldehyde from ethylene glycol. These by-products are easily combustible, malodorous, dangerous to health and pass into the flushing nitrogen with which the paste is normally covered in the mixing- and storage container and which hence cannot be released to the environment without further treatment.

Another reason is the hydrolysis-sensitivity, in particular of the Ti- and Zr alkoxides. The hydroscopic properties of many diols, such as ethylene glycol or butanediol, lead to them not being completely water-free even in the delivered condition and, during paste production, absorb even more water due to contact with the ambient air. This absorption can only be avoided by complex countermeasures, such as nitrogen covering when emptying, storing and metering both of the dicarboxylic acid- and of the diol components of the polyester. Also a small water concentration in the paste leads, because of the normally long dwell time in the mixing- and storage container of the paste, to partial hydrolysis of the Ti- and Zr alkoxides which reduces the catalytic activity and leads to undesired clouding of the polyester due to the resulting hydroxides or oxides of these metals.

With the choice of simultaneously hydrolysis-stable and catalytically active Ti- and Zr compounds, according to the invention the catalyst can now be supplied, surprisingly directly, to the paste without requiring great complexity, during the inertisation, by emptying, storing and metering the raw material components of the polyester.

Compared with the addition into the esterification reactor, the addition into the paste thereby has essential advantages: the catalyst is distributed uniformly in the paste, before this is heated to reaction temperature in the reactor. In contrast, metering of the catalyst directly into the reactor in the surroundings of the entry place in the reacting melt leads locally to a high concentration. This promotes undesired subsidiary reactions, e.g. hydrolysis of the catalyst, due to the effect of the water formed chemically by the esterification reaction at high temperature which reduces the catalytic activity, the colouration of the polyester which reduces the product quality or the formation of undesired by-products in an increased quantity, such as tetrahydrofuran from butanediol or acetaldehyde from ethylene glycol, which reduce the yield of the polymerisation and increase the requirement for raw materials.

In addition, the metering into the pressureless paste mixer is more precise and more reliable than into a reactor which is under vacuum or pressure at high temperature.

The polyester which is obtained according to the method according to the invention is present, after cooling, preferably in granulate form and hence can then be processed without difficulty to form moulded articles by means of form tools which are known per se in the state of the art, e.g. via an extruder by means of extrusion or injection moulding.

Determination of the solution viscosity is effected corresponding to ISO 1628-5 on a solution of the polyester in a concentration of 0.5 g/dl in a suitable solvent, such as e.g. m-cresol or hexafluoroisopropanol or in a solvent mixture, such as e.g. phenol/dichlorobenzene. Preferably, a solvent mixture of phenol and dichlorobenzene with a 1:1 mass proportion is used, thereafter, determination of the throughflow times of solution and solvent in suitable capillaries of the Ubbelohde type at 25.0° C. is effected. From the quotient of the throughflow times of the solution and of the solvent, the relative viscosity R.V. is subsequently determined.

The average molecular weight for the weight average Mw is at least 100,000 Da, determined according to the method of gel permeation chromatography (GPC) with connected refractive index detector by means of a solution of the polyesters in the solvent chloroform (2 mg/ml), calibrated against polystyrene standard with a narrow molar mass distribution.

The method according to the invention is explained subsequently in more detail with reference to the individual method steps.

According to the invention, it is provided that, for the production of the high-molecular copolyester, in a first method step, at least one aromatic dicarboxylic acid or the diester or an acid anhydride of an aromatic dicarboxylic acid with 4 to 12 C atoms and at least one aliphatic dicarboxylic acid with 2 to 14 C atoms and at least one alcohol of 2 to 12 C atoms and at least 2 hydroxy functionalities and also optionally further aromatic, heteroaromatic and/or aliphatic dicarboxylic acids or aliphatic dicarboxylic acids, diesters or acid anhydrides derived herefrom and possibly further comonomers is processed by mixing to form a paste and to which the total quantity of catalyst for the esterification- or transesterification reaction and also the subsequent polycondensation is added.

The aromatic or heteroaromatic dicarboxylic acids with 4 to 12 carbon atoms, which are used according to the invention, can thereby represent linear or aromatic or heteroaromatic branched dicarboxylic acids.

Likewise, acid anhydrides or the diesters thereof which are derived from the aromatic or heteroaromatic dicarboxylic acids can be used. Likewise, a mixture of the mentioned aromatic or heteroaromatic dicarboxylic acids and the derived acid anhydrides and or the diesters is conceivable. There are preferred aromatic or heteroaromatic dicarboxylic acids or the diesters thereof, selected from the group consisting of terephthalic acid, isophthalic acid, phthalic acid, 2,5-furandicarboxylic acid, naphthalene dicarboxylic acid. Terephthalic acid and also 2,5-furandicarboxylic acid are particularly preferred.

The aliphatic dicarboxylic acids with 2 to 12 carbon atoms which are used according to the invention can thereby represent linear or branched aliphatic dicarboxylic acids. Likewise, acid anhydrides or diesters derived from the aliphatic dicarboxylic acids can be used. The acid anhydrides can thereby represent for example cyclic or mixed acid anhydrides. A mixture of the mentioned aliphatic dicarboxylic acids and the derived acid anhydrides and/or the diesters is likewise conceivable. In addition, it is possible that the aliphatic dicarboxylic acids or the derived acid anhydrides or diesters thereof are used as pure substance, it is also possible that more than one aliphatic dicarboxylic acid is used, for example as a mixture of a plurality of dicarboxylic acids or the anhydrides or diesters thereof. There are preferred aliphatic dicarboxylic acids selected from the group consisting of malonic acid, oxalic acid, succinic acid, glutaric acid, 2-methylglutaric acid, 3-methylglutaric acid, adipic acid, pimelic acid, octanedioic acid, azelaic acid, sebacic acid, undecanedioic acid, dodecanedioic acid, brassylic acid, tetradecanedioic acid, 3,3-dimethylpentanedioc acid, fumaric acid, 2,2-dimethylglutaric acid, suberic acid, dimer fatty acid, 1,3-cyclopentanedicarboxylic acid, 1,4-cyclohexanedicarboxylic acid, 1,3-cyclohexanedicarboxylic acid, diglycolic acid, itaconic acid, maleic acid, maleic acid anhydride, 2,5-norbornanedicarboxylic acid or the esters, anhydrides thereof or mixtures hereof, adipic acid and also succinic acid and the diesters thereof are particularly preferred.

The alkanol with 2-12 carbon atoms which is used according to the invention can thereby likewise have a linear or branched aliphatic basic body. The alkanol is preferably a glycol, i.e. has two hydroxy functionalities. The hydroxy functionalities are thereby preferably primary or secondary, in particular primary hydroxy functionalities. It is advantageous if the at least one alcohol is selected from the group consisting of ethylene glycol, 1,2-propanediol, 1,3-propanediol, 1,2-butanediol, 1,4-butanediol, 1,5-pentanediol, 1,6-hexanediol, 2,4-dimethyl-2-ethylhexane-1,3-diol, 2,2-dimethyl-1,3-propanediol, 2-ethyl-2-butyl-1,3-propanediol, 2-ethyl-2-isobutyl-1,3-propanediol, 2,2,4-trimethyl-1,6-hexanediol, cyclopentanediol, 1,4-cyclohexanediol, 1,2-cyclohexanedimethanol, 1,3-cyclohexanedimethanol, 1,4-cyclohexanedimethanol or 2,2,4,4-tetramethyl-1,3-cyclobutanediol or mixtures hereof. 1,4-butanediol and also 1,3-propanediol are particularly preferred.

Preferably, further comonomers can be used in step a). There are suitable as comonomers, hydroxycarboxylic acids, oligomeric compounds, such as polyether alcohols, diamines, aminoalcohols, sulphodicarboxylic acids without restricting the type of compounds which can be condensed into the polymer chain by the cited selection. For particular preference here, comonomers are selected from the group consisting of lactic acid, lactic acid oligomers, hydroxybutanoic acid, hydroxybutanoic acid oligomers, polyethylene glycol, polypropylene glycol, glycerine, trimethylolpropane, pentaerythrite or citric acid or mixtures hereof.

The stoichiometric ratio of the total quantity of carboxyl functionalities to the total quantity of hydroxyl functionalities in step a) is preferably in the range of 1:0.5 to 1:5.0, preferably of 1:0.9 to 1:3.0, particularly preferred is 1:1.1 to 1:2.0.

Furthermore it is preferred in step a) that the processing to form the paste is effected at temperatures in the range of +10° C. to +120° C., preferably the paste being maintained in a flowable and also conveyable state by means of pumps due to technical measures, such as stirring members, mixing nozzles, circulation lines etc. and sedimenting-out of individual components of the paste being prevented.

Preferably, the hydrolysis-stable catalyst is selected from the group consisting of titanium salts and zirconium salts, in particular from organic acids, preferably oxalic acid, lactic acid, citric acid, acetoacetic acid and the esters thereof, and/or acetylacetone and/or inorganic acids, in particular phosphoric acid, and/or chelates of titanium salts or of zirconium salts derived from ethanol amines separately and/or mixtures or solutions thereof, the catalyst preferably having a purity of >99.9% by weight of titanium or zirconium.

The catalyst is thereby used, in step a), preferably in a concentration of 1 to 20,000 ppm, preferably of 10 to 10,000 ppm, relative to the weight sum of the monomers and oligomers which are used.

There should be mentioned as chain branching agents, branching components, such as e.g. multivalent carboxylic acids (propanetricarboxylic acid, pyromellitic acid, or acid anhydrides and also multivalent alcohols). The following compounds should be mentioned here by way of example:

tartaric acid, citric acid, malic acid, trimethylolpropane, trimethylolethane; pentaerythrite; polyether triols and glycerine, trimesic acid, trimellitic acid, trimellitic acid anhydride, pyromellitic acid and pyromellitic acid anhydride. Polyols, such as trimethylolpropane, pentaerythrite and in particular glycerine are preferred.

In particular, the chain branchings should improve the processing properties, e.g. in the case of film blowing. In order to avoid gelatinisation, the proportion of branching components should be <1% by mol. The long-chain branchings should have the effect that the polymer has higher stability in the melt and also a higher crystallisation temperature. Trimethylolpropane and glycerine are preferably used.

There are used preferably as chain lengtheners, aliphatic, di- or higher-functional epoxides, carbodiimides or diisocyanates, oxazolines or dianhydrides, preferably in a quantity of 0.01 to 4% by weight, relative to the mass of the polyester or copolyester. As a result, the polymer obtains its ultimate properties, in particular sufficiently high melt viscosities for further processing.

By means of metering and mixing devices known according to the state of the art, the chain lengtheners can be added to the polymer before, during or after step c), mixed in homogeneously and made to react. Ideally, the chain lengtheners are present at room temperature or increased temperature in liquid form and are mixed in, for example by means of a conveying system to be operated continuously with two metering pumps connected in series and a subsequently connected static mixer, comparable to application WO 2007/054376 A1, and made to react.

There are possible as chain lengtheners, difunctional or oligofunctional epoxides, such as: hydroquinone, diglycidyl ether, resorcinol diglycidyl ether, 1,6-hexanediol diglycidyl ether and hydrated bisphenol-A-diglycidyl ether. Other examples of epoxides comprise diglycidyl terephthalate, phenylene diglycidyl ether, ethylene diglycidyl ether, trimethylene diglycidyl ether, tetramethylene diglycidyl ether, hexamethylene diglycidyl ether, sorbitol diglycidyl ether, polyglycerine polyglycidyl ether, pentaerythrite polyglycidyl ether, diglycerol polyglycidyl ether, glycerol polyglycidyl ether, trimethylolpropane polyglycidyl ether, resorcinol diglycidyl ether, neopentyl glycol diglycidyl ether, ethylene glycol diglycidyl ether, diethylene glycol diglycidyl ether, polyethylene glycol diglycidyl ether, propylene glycol diglycidyl ether, dipropylene glycol diglycidyl ether, polypropylene glycol diglycidyl ether and polybutydiene glycol diglycidyl ether.

As chain lengthener, there is suitable in particular an epoxide group-containing copolymer based on styrene, acrylic acid ester and/or methacrylic acid ester. The units carrying epoxide groups are preferably glycidyl (meth)acrylates. Copolymers with a glycidyl methacrylate proportion greater than 20, particularly preferred of greater than 30 and particularly preferred of greater than 50% by weight of the copolymer have proved to be advantageous. The epoxide equivalent weight (EEW) in these polymers is preferably 150 to 3,000 and particularly preferred 200 to 500 g/equivalent. The average molecular weight (weight average) Mw of the polymers is preferably 2,000 to 25,000, in particular 3,000 to 8,000. The average molecular weight (number average) Mₙ of the polymers is preferably 400 to 6,000, in particular 1,000 to 4,000. The polydispersity (Q) is in general between 1.5 and 5. Epoxide group-containing copolymers of the above-mentioned type are for example marketed by BASF Resins B.V. under the trade name Joncryl® ADR. There are particularly suitable as chain lengtheners, Joncryl® ADR 4368, long-chain acrylates, as described in the EP application no. 08166596.0 and Cardura® E10 by the Shell Company.

Bisoxazolines are obtainable in general by the method from App. Chem. Int. Ed., Vol. 11 (1972), p. 287-288. Particularly preferred bisoxazolines and bisoxazines are those in which the bridge member means a single bond, a (CH₂)-alkylene group, with z=2, 3 or 4, such as methylene, ethane-1,2-diyl, propane-1,3-diyl, propane-1,2-diyl, or a phenylene group. There are mentioned as particularly preferred bisoxazolines 2,2′-bis(2-oxazoline), bis(2-oxazolinyl)methane, 1,2-bis(2-oxazolinyl)ethane, 1,3-bis(2-oxazolinyl)propane or 1,4-bis(2-oxazolinyl)butane, in particular 1,4-bis(2-oxazolinyl)benzene, 1,2-bis(2-oxazolinyl)benzene or 1,3-bis(2-oxazolinyl)benzene. Further examples are: 2,2′-bis(2-oxazoline), 2,2′-bis(4-methyl-2-oxazoline), 2,2′-bis(4,4′-dimethyl-2-oxazoline), 2,2′-bis(4-ethyl-2-oxazoline), 2,2′-bis(4,4′-diethyl-2-oxazoline), 2,2′-bis(4-propyl-2-oxazoline), 2,2′-bis(4-butyl-2-oxazoline), 2,2′-bis(4-hexyl-2-oxazoline), 2,2′-bis(4-phenyl-2-oxazoline), 2,2′-bis(4-cyclohexyl-2-oxazoline), 2,2′-bis(4-benzyl-2-oxazoline), 2,2′-p-phenylene-bis(4-methyl-2-oxazoline), 2,2′-p-phenylene-bis(4,4′dimethyl-2-oxazoline), 2,2′-p-phenylene-bis(4methyl-2-oxazoline), 2,2′-m-phenylene-bis(4,4′-dimethyl-2-oxazoline), 2,2′-hexamethylene-bis (2-oxazoline), 2,2′-octamethylene-bis (2-oxazoline), 2,2′-decamethylene-bis (2-oxazoline), 2,2′-ethylene-bis(4-methyl-2-oxazoline), 2,2′-tetramethylene-bis(4,4′-dimethyl-2-oxazoline), 2,2′,9,9′-diphenoxyethane-bis (2-oxazoline), 2,2′-cyclohexylene-bis(2-oxazoline) and 2,2′-diphenylene-bis (2-oxazoline).

Preferred bisoxazines are 2,2′-bis(2-oxazine), bis(2-oxazinyl)methane, 1,2-bis(2-oxazinyl)ethane, 1,3-bis(2-oxazinyl)propane or 1,4-bis(2-oxazinyl)butane, in particular 1,4-bis(2-oxazinyl)benzene, 1,2-bis(2-oxazinyl)benzene or 1,3-bis(2-oxazinyl)benzene.

Carbodiimides and polymeric carbodiimides are marketed for example by the Lanxess Company under the trade name Stabaxol® or by the Elastogran Company under the trade name Elastostab®.

Examples are: N,N′-di-2,6-diisopropylphenylcarbodiimide, N,N′-di-o-tolylcarbodiimide, N,N′-diphenylcarbodiimide, N,N′-dioctyldecylcarbodiimide, N,N′-di-2,6-dimethylphenylcarbodiimide, N-tolyl-N′-cyclohexylcarbodiimide, N,N′-di-2,6-di-tert.-butylphenylcarbodiimide, N-tolyl-N′-phenylcarbodiimide, N,N′-di-p-hydroxyphenylcarbodiimide, N,N′-di-cyclohexylcarbodiimide, N,N′-di-p-tolylcarbodiimide, p-phenylene-bis-di-o-tolylcarbodiimide, p-phenylene-bis-dicyclohexylcarbodiimide, hexamethylene-bis-dicyclohexylcarbodiimide, 4,4′-dicyclohexylmethanecarbodiimide, ethylene-bis-diphenylcarbodiimide, N,N′-benzylcarbodiimide, N-octadecyl-N′-phenylcarbodiimide, N-benzyl-N′-phenylcarbodiimide, N-octadecyl-N′-tolylcarbodiimide, N-cyclohexyl-N′-tolylcarbodiimide, N-phenyl-N′-tolylcarbodiimide, N-benzyl-N′-tolylcarbodiimide, N,N′-di-o-ethylphenylcarbodiimide, N,N′-di-p-ethylphenylcarbodiimide, N,N′-di-o-isopropylphenylcarbodiimide, N,N′-di-p-isopropylphenylcarbodiimide, N,N′-di-o-isobutylphenylcarbodiimide, N,N′-di-p-isobutylphenylcarbodiimide, N,N′-di-2,6-diethylphenylcarbodiimide, N,N′-di-2-ethyl-6-isopropylphenylcarbodiimide, N,N′-di-2-isobutyl-6-isopropylphenylcarbodiimide, N,N′-di-2,4,6-trimethylphenylcarbodiimide, N,N′-di-2,4,6-triisopropylphenylcarbodiimide, N,N′-di-2,4,6-triisobutylphenylcarbodiimide, di-isopropylcarbodiimide, dimethylcarbodiimide, diisobutylcarbodiimide, dioctylcarbodiimide, t-butylisopropylcarbodiimide, di-8-naphthylcarbodiimide and di-t-butylcarbodiimide.

The chain lengthener is used in 0.01 to 4% by weight, preferably in 0.1 to 2% by weight and particularly preferred in 0.2 to 1% by weight, relative to the polyester.

There are preferred as diisocyanates ethylene diisocyanate, 1,4-tetramethylene diisocyanate, 1,4-tetramethoxybutane diisocyanate, 1,6-hexamethylene diisocyanate (HDI), cyclobutane-1,3-diisocyanate, cyclohexane-1,3- and -1,4-diisocyanate, bis(2-isocyanato-ethyl)fumarate, 1-isocyanato-3,3,5-trimethyl-5-isocyanatomethylcyclohexane (isophoron diisocyanate, IPDI), 2,4- and 2,6-hexahydrotoluylene diisocyanate, hexahydro-1,3- or -1,4-phenylene diisocyanate, benzidine diisocyanate, naphthalene-1,5-diisocyanate, 1,6-diisocyanato-2,2,4-trimethylhexane, 1,6-diisocyanato-2,4,4-trimethylhexane, xylylene diisocyanate (XDI), tetramethylxylylene diisocyanate (TMXDI), 1,3- and 1,4-phenylene diisocyanate, 2,4- or 2,6-toluylene diisocyanate (TDI), 2,4′-diphenylmethane diisocyanate, 2,2′-diphenylmethane diisocyanate or 4,4′-diphenylmethane diisocyanate (MDI) and the isomer mixtures thereof. Further possible inclusions are partially or completely hydrated cycloalkyl derivatives of MDI, for example completely hydrated MDI (H12-MDI), alkyl-substituted diphenylmethane diisocyanates, for example mono, -di, -tri- or tetraalkyldiphenylmethane diisocyanate and also the partially or completely hydrated cycloalkyl derivatives thereof, 4,4′-diisocyanatophenylperfluoroethane, phthalic acid-bis-isocyanatoethyl ester, 1-chloromethylphenyl-2,4- or -2,6-diisocyanate, 1-bromomethylphenyl-2,4- or -2,6-diisocyanate, 3,3-bis-chloromethylether-4,4′-diphenyldiisocyanate, sulphur-containing, as can be obtained by conversion of 2 mol diisocyanate with 1 mol thiodiglycol or dihydroxydihexylsulphide, those of the dimer fatty acids, or mixtures of two or more of those mentioned. Particularly preferred are 1,6-hexamethylene diisocyanate (HDI) and 4,4′-diphenylmethane diisocyanate (MDI).

Preferably, there is added, before and/or during step c), at least one co-catalyst, in particular selected from the group of antimony- or cobalt salts and/or at least one stabiliser, in particular from the group of inorganic phosphorus salts or phosphorus acids, organic phosphorus compounds or stabilisers from the group of the Irganox® types. This is added preferably in a quantity of 10 to 10,000 ppm, particularly preferred of 10 to 1,000 ppm.

All additives which can be used in the polymer industry are in practice conceivable as additives, such as e.g.:
lubricants, such as e.g. metal stearates,
mould-release agents, such as e.g. fatty acid alcoholates or paraffin waxes,
silicone compounds,
nucleation agents,
fillers, such as e.g. titanium dioxide, talcum, gypsum, lime, chalk, silicates, clays, carbon black, lignin, cellulose, starch, nanoparticles and
inorganic or organic pigments for colouring or colour correction,
mixtures hereof.

This list should not hereby be regarded as a conclusive list of possible additives.

It is known from various patents that additives (e.g. phosphorus-containing stabilisers, such as phosphoric acid or phosphorous acid) are added in the production of polymers. It emerges from U.S. Pat. No. 6,399,716 that, with a content of <0.02% by weight of stabiliser, the colour of the product becomes yellow/brown, whilst, with a content >2% by weight, the reaction progress is inadequate. In addition, a series of further additives can be added, such as e.g. heat stabilisers, antioxidants, nucleation agents, flame-retardants, antistatic agents, processing aids, UV stabilisers and also reinforcing materials or fillers.

Preferably, esterification or transesterification is effected in step b) at a temperature of 150 to 250° C. and at a pressure of 0.7 to 4 bar. In step b) and/or subsequent to step b), preferably by-products or condensation products which are present in vaporous form during normal conditions from 60° C. onwards, in particular water or methanol, are thereby removed at least partially or entirely.

It is further preferred that, in step c), the poly- or copolycondensation is implemented in two steps, a polyester prepolymer or copolyester prepolymer being produced, in a first partial step c1), from the reaction product, obtained from step b), by polycondensation or copolycondensation and, in a subsequent partial step c2), a polyester or copolyester with a relative viscosity R.V. of at least 1.5 being produced from the polyester prepolymer or copolyester prepolymer from partial step c1), by polycondensation or copolycondensation, the partial steps being implemented in one or more reactors. The implementation thereby takes place, in step c1), at a pressure of 0.1 bar to 2 bar, particularly preferred of 0.15 bar to 1.0 bar, in particular of 0.2 bar to 0.7 bar, and at temperatures of 160 to 300° C., preferably of 200 to 260° C., and preferably, in step c2), at reduced pressure relative to normal conditions, preferably at a pressure of 0.1 mbar to 30 mbar, particularly preferred of 0.2 mbar to 10 mbar, in particular of 0.4 mbar and 5 mbar, and at temperatures of 200 to 300° C., preferably of 220 to 270° C.

Furthermore, the method according to the invention provides, insofar as the relative viscosity which is achieved with the method after method step c) is not yet adequate for the sought applications, that the reaction product, after step c), after cooling and conversion into granulate- and/or powder form and also crystallisation, is subjected to a postcondensation in the solid phase. Such postcondensations in the solid phase (SSP) are known from polyester chemistry. The method conditions known there can also be applied for the postcondensation in the case of the heteroaromatic polyester produced according to the invention. Preferred temperatures for the postcondensation of the described polyesters in the solid phase are in the range of approx. 10-50 K below the melting temperature of the polymer. For the postcondensation, as known in the state of the art, a dry inert gas is guided in counterflow to the granulates in a suitable reactor. As inert gas, there can be thereby used an inert gas from the group, nitrogen, carbon dioxide and/or argon. Alternatively, the process can take place during the solid phase postcondensation (SSP), also preferably with a pressure level of 0.001 to 0.2 bar in the indicated temperature range.

The granulates and/or powders produced according to the method according to the invention, after method step c), can also be subjected to a subsequent treatment such that the granulates and/or the powder are freed of reaction products. Such volatile reaction products or reaction by-products can be for example acetaldehyde, methyldioxolane, acrolein, water or tetrohydrofuran. The freeing from these by-products can be effected by being subjected to a gas flow or a mixture of gases from the group air, nitrogen or CO₂ with a water dew point of preferably −100° C. to 10° C., particularly preferred of −70° C. to −20° C. at a temperature of 80 to 200° C., preferably of 100 to 150° C. The two method steps of postcondensation in the solid phase and the subsequent treatment for removing volatile compounds can also be effected in a common method step in the indicated temperature range with the indicated gases or gas mixtures or at low pressure.

As a result of the two above-described measures, the mechanical and physical properties of the produced granulates and hence also of the moulded parts produced therefrom can be improved in a sustainable manner.

The method according to the invention—as described above—is suitable in a particularly preferred manner for the production of polybutylene succinate-co-terephthalate and polybutylene adipate-co-terephthalate.

The polyesters or copolyesters produced according to the invention can be processed with processing machines according to the state of the art of plastic material processing, after heating, by extrusion or injection moulding or casting to form biodegradable films, foils, plates, fibres, filaments, foams or moulded articles. The polymers produced according to the invention can be processed for this purpose directly after production thereof and possibly intermediate drying processes or be processed in the form of mixtures or blends or compounds with other, in particular biodegradable, polymers, such as polyglycolic acids, polylactic acids, polyhydroxyalkanoates, polycaprolactons, to form articles.

The definition according to DIN EN 13432 applies for biodegradable in the sense of this invention, a percentage degree of degradability of at least 90% requiring to be fulfilled.

Preferably, the polyester or copolyester comprises from 0.1% to 100% and particularly preferred from 5.0% to 99%, relative to the sum of all carbon atoms, of those carbon atoms which are available from renewable sources, in particular using monomers or oligomers from the group of bio-based 2,5-furandicarboxylic acid, bio-based terephthalic acid, bio-based succinic acid, bio-based adipic acid, bio-based sebacic acid, bio-based ethylene glycol, bio-based propanediol, bio-based 1,4-butanediol, bio-based isosorbide, bio-based lactic acid, bio-based citric acid, bio-based glycerine, bio-based polylactic acid or bio-based polyhydroxybutanoic acid or bio-based polyhydroxybutanoic acid derivatives.

It is further preferred that the polyester or copolyester comprises at least one heteroaromatic or aromatic dicarboxylic acid in a quantity of 20 to 80% by mol, preferably 40 to 60% by mol and at least one aliphatic dicarboxylic acid in a quantity of 80 to 20% by mol, preferably of 60 to 40% by mol, respectively relative to the sum of all the dicarboxylic acids used.

According to the invention, likewise a biodegradable polymer blend is provided which consists of 10 to 90% by weight of the polyester or copolyester according to the invention and also 90 to 10% by weight of a biodegradable polymer, in particular from the group, polyglycolic acid, polylactic acid, polyhydroxybutanoic acid, polyhydroxybutanoic acid copolyester, starch, cellulose, polycaprolacton, lignin, and also 0 to 5% by weight of a non-bio-based component or essentially comprises these.

The polyesters or copolyesters according to the invention are used in the production of compostible moulded articles, biodegradable foams and paper-coating means.

The subject according to the invention is intended to be explained in more detail with reference to the subsequent examples without wishing to restrict said subject to the specific embodiments represented here.

### EXAMPLES

In the tests, the quantities of adipic acid or succinic acid and also terephthalic acid and butanediol, which are indicated below, together with the catalyst, were placed in a 500 ml three-neck flask with a column and reflux cooler placed thereon under a nitrogen atmosphere. After a heating bath temperature of 230° C. was reached, the vessel with the reaction mixture was lowered into the heating medium under N₂ conduction and the stirrer was started (t₀). A speed of rotation of 150 rpm was maintained during the test. Via a distillation column operated at 105° C., the resulting vapours were separated and the over-distilling water was collected. After respectively 7:15 h, the corresponding monomers/esterification products were obtained (see table 1 and 2).

The following abbreviations are used in the subsequent tables:
ADS: adipic acid
SAC: succinic acid
PTA: terephthalic acid
BDO: 1,4-butanediol
MV: mixture ratio of dicarboxylic acids/dialcohol (mol/mol)
Cat: Catalyst
TiTBT: titanium tetrabutylate
R.V.: relative viscosity
t: reaction time
T: prevailing reaction temperature
COOH: total number of carboxyl groups
MW: molar mass (weight average), determined by means of GPC

TABLE 1

| | PTA | ADS | SAC | BDO | | | |
|---|---|---|---|---|---|---|---|
| Test | [g] | [g] | [g] | [g] | MV | cat. | cat. [ppm] |
| V4M | 166.1 | 0 | 118.1 | 270.4 | 1:1.5 | chelate 1 | 200 ppm Ti |
| V5M | 166.1 | 146.1 | 0 | 270.4 | 1:1.5 | TiTBT | 200 ppm Ti |
| V6M | 168.2 | 148.1 | 0 | 274.4 | 1:1.5 | chelate 2 | 200 ppm Ti |
| | | | | | | highly pure | |
| V7M | 169.2 | 148.8 | 0 | 275.4 | 1:1.5 | chelate 2 | 200 ppm Ti |

In the test V4M according to the invention, a polytetramethylene succinate terephthalate (PBST) was produced. In the comparative example V5M column a non-hydrolysis-stable catalyst TiTBT was used. In the test V6M according to the invention, a highly pure Ti-chelate catalyst was used for the production of PBST. In the test V7M according to the invention, a Ti-chelate catalyst was used for the production of polybutylene adipate terephthalate (PBAT).

TABLE 2

| | | Temper- | | | | Yield [%] |
|---|---|---|---|---|---|---|
| | T | ature | Distillate | COOH | | esterification |
| Test | [h:min] | [° C.] | [ml] | [mmol/kg] | R.V. | product |
| V4M | 7:15 | 230 | 87 | 47.9 | 1.047 | 90.5 |
| V5M | 7:15 | 230 | 80 | 287 | 1.048 | 90.8 |
| V6M | 7:15 | 230 | 73 | 36.1 | 1.052 | 90.4 |
| V7M | 7:15 | 230 | 79 | 46.7 | 1.050 | 90.6 |

For the subsequent polycondensation reactions, respectively 50 g of the previously produced esterification products were placed in a laboratory glass polycondensation apparatus. After reaching a heating bath temperature of 230° C., the apparatus with the esterification product was lowered into the heating bath under N2 conduction. Approx. 15 minutes later, the stirrer was switched on and a vacuum applied and also the pressure was lowered in steps and the reference temperature for the heating bath was increased to 250° C. (which was then reached after approx. 60 minutes). After a further 120 min. the heating bath temperature was increased to 255° C. Approx. 15 minutes after switching on the stirrer at a speed of rotation of 200 rpm, the end vacuum of approx. 0.5-1.5 mbar was reached. Six hours after the beginning of application of the vacuum, nitrogen was introduced into the apparatus and the following samples/polycondensation products were obtained (see Table 3).

TABLE 3

| Test | T [° C.] | T [h:min] | COOH [mmol/kg] | R.V. | MW [Da] |
|---|---|---|---|---|---|
| V4M | 255 | 6:00 | 60.8 | 1.649 | 106,350 |
| V5M | 255 | 6:00 | 19.6 | 1.441 | 82,260 |
| V6M | 255 | 6:00 | 28.0 | 1.852 | 127,700 |
| V7M | 255 | 6:00 | 35.4 | 1.660 | 118,450 |

1. A method for the continuous or discontinuous production of a high-molecular polyester or copolyester, in which
a) in a first step, the total quantity of the monomers or oligomers which are capable of condensation reactions, comprising at least one aromatic or heteroaromatic C₄-C₁₂ dicarboxylic acid or the diesters thereof, at least one aliphatic C₂-C₁₂ dicarboxylic acid or the diester thereof, at least one C₂-C₁₂ alkanol with at least two hydroxyl groups, are processed by mixing to form a paste, at least one hydrolysis-stable catalyst being added during the production of the paste or into the already produced paste, the total quantity or a main quantity of at least 50% by weight, relative to the total quantity of the catalyst, being added,
b) in a second step, the paste is converted by increasing the temperature and with distilling-off of condensation products or transesterification products to form an esterification- or transesterification product and
c) the esterification- or transesterification product obtained from step b) is polycondensed or copolycondensed at reduced pressure relative to normal conditions up to a molecular weight Mₙ of 100,000 to 150,000 g/mol and to a relative viscosity of 1.5 to 2.0.

2. The method according to claim 1, wherein
the at least one aromatic or heteroaromatic C₄-C₁₂ dicarboxylic acid is selected from the group consisting of terephthalic acid, isophthalic acid, naphthalene dicarboxylic acid or 2,5-furandicarboxylic acid or the esters, anhydrides and mixtures thereof, and/or
the at least one aliphatic C₂-C₁₂ dicarboxylic acid is selected from the group consisting of malonic acid, oxalic acid, succinic acid, glutaric acid, 2-methylglutaric acid, 3-methylglutaric acid, adipic acid, pimelic acid, octanedioic acid, azelaic acid, sebacic acid, undecanedioic acid, dodecanedioic acid, brassylic acid, tetradecanedioic acid, 3,3-dimethylpentanedioc acid, fumaric acid, 2,2-dimethylglutaric acid, suberic acid, dimer fatty acid, 1,3-cyclopentanedicarboxylic acid, 1,4-cyclohexanedicarboxylic acid, 1,3-cyclohexanedicarboxylic acid, diglycolic acid, itaconic acid, maleic acid, maleic acid anhydride, 2,5-norbornanedicarboxylic acid or the esters, anhydrides thereof and mixtures thereof, and/or
the at least one C₂-C₁₂ alkanol is selected from the group consisting of ethylene glycol, 1,2-propanediol, 1,3-propanediol, 1,2-butanediol, 1,4-butanediol, 1,5-pentanediol, 1,6-hexanediol, 2,4-dimethyl-2-ethylhexane-1,3-diol, 2,2-dimethyl-1,3-propanediol, 2-ethyl-2-butyl-1,3-propanediol, 2-ethyl-2-isobutyl-1,3-propanediol, 2,2,4-trimethyl-1,6-hexanediol, cyclopentanediol, 1,4-cyclohexanediol, 1,2-cyclohexanedimethanol, 1,3-cyclohexanedimethanol, 1,4-cyclohexanedimethanol or 2,2,4,4-tetramethyl-1,3-cyclobutanediol and mixtures thereof.

3. The method according to claim 1,
wherein, in step a), further comonomers are added, which are selected from the group consisting of lactic acid, lactic acid oligomers, hydroxybutanoic acid, hydroxybutanoic acid oligomers, polyethylene glycol, polypropylene glycol, glycerine, trimethylolpropane, pentaerythrite citric acid and mixtures thereof.

4. The method according to claim 1,
wherein, in step a), the stoichiometric ratio of the total quantity of carboxyl functionalities to the total quantity of hydroxyl functionalities is in the range of 1:0.5 to 1:5.0.

5. The method according to claim 1,
wherein, in step a), the processing to form the paste is effected at temperatures in the range of +10° C. to +120° C.

6. The method according to claim 1,
wherein the hydrolysis-stable catalyst is selected from the group consisting of titanium salts and zirconium salts, organic acids, and acetylacetone, inorganic acids, and chelates of titanium salts or of zirconium salts derived from ethanol amines separately and/or mixtures or solutions thereof, the catalyst having a purity of >99.9% by weight of titanium or zirconium, the hydrolysis-stable catalyst being used in a concentration of 1 to 20,000 ppm, relative to the weight sum of the monomers and oligomers which are used.

7. The method according to claim 1,
wherein the esterification or transesterification is effected, in step b), at a temperature of 150 to 250° C. and at a pressure of 0.7 to 4 bar.

8. The method according to claim 1,
wherein, in step c), the poly- or copolycondensation is implemented in two steps, a polyester prepolymer or copolyester prepolymer being produced, in a first partial step c1), from the reaction product, obtained from step b), by polycondensation or copolycondensation and, in a subsequent partial step c2), a polyester or copolyester with a relative viscosity of 1.5 to 2.0 being produced from the polyester prepolymer or copolyester prepolymer from partial step c1), by polycondensation or copolycondensation, the partial steps being implemented in one or more reactors.

9. The method according to claim 1,
wherein there is added, before and/or during step c) or before step c1) or during step c1) or c2), at least one of the following components:
at least one co-catalyst, in particular selected from the group of tin-, antimony- or cobalt salts and/or at least one stabiliser,
lubricants,
mould-release agents,
silicone compounds,
nucleation agents,
fillers, and
inorganic or organic pigments for colouring or colour correction,
mixtures thereof.

10. The method according to claim 1,
wherein
a) the reaction product produced in step b) is adjusted to a relative viscosity R.V. of 1.02 to 1.1, and/or
b) the polyester produced in step c) is adjusted to a relative viscosity of 1.5 to 2.50.

11. The method according to claim 1, wherein the reaction product, before, during or after step c), is subjected to a chain-lengthening step by addition of a reactive compound selected from the group of di- or higher-functional epoxides, carbodiimides or diisocyanates, oxazolines or dianhydrides.

12. The method according to claim 1, wherein the reaction product obtained before, during or after step c), after cooling and conversion into a granulate- and/or powder form and also crystallisation, is subjected to at least one of the following steps:
postcondensation in the solid phase in order to increase the molar mass at a temperature of 100-230° C., but at most 10 K below the melting temperature of the polyester or copolyester with delivery of an inert gas or a mixture of inert gases from the group, nitrogen, carbon dioxide, argon or by lowering to a reduced pressure relative to atmospheric pressure of pressure level 0.01 to 0.2 bar
removal of one or more volatile reaction- or by-products from the group acetaldehyde, methyldioxolane, acrolein, water or tetrohydrofuran with delivery of a gas flow or a mixture of gases from the group, air, nitrogen, argon or carbon dioxide with a water dew point of 100° C. to 10° C.

13. A polyester or copolyester producible according to the method of claim 1, and biodegradable according to EN 13432.

14. A polyester or copolyester according to claim 13, wherein the polyester or copolyester comprises from 0.1% to 100%, relative to the sum of all carbon atoms, of those carbon atoms which are available from renewable sources, utilizing monomers or oligomers from the group of bio-based 2,5-furandicarboxylic acid, bio-based terephthalic acid, bio-based succinic acid, bio-based adipic acid, bio-based sebacic acid, bio-based ethylene glycol, bio-based propanediol, bio-based 1,4-butanediol, bio-based isosorbide, bio-based lactic acid, bio-based citric acid, bio-based glycerine, bio-based polylactic acid and bio-based polyhydroxybutanoic acid.

15. A polyester or copolyester according to claim 13,
wherein the polyester or copolyester comprises at least one heteroaromatic or aromatic dicarboxylic acid in a quantity of 20 to 80% by mol and at least one aliphatic dicarboxylic acid in a quantity of 80 to 20% by mol, relative to the sum of all the dicarboxylic acids used.

16. A biodegradable polymer blend consisting of 10 to 90% by weight of a polyester or copolyester according to claim 13 and 90 to 10% by weight of a biodegradable polymer, and 0 to 5% by weight of a non-bio-based component.

17. A method of producing compostible moulded articles biodegradable foams and paper-coating means comprising utilizing the polyester or copolyester according to claim 13.
